(19) United States
(12) Patent Application Publication
(10) Pub. No.: US 2008/0129434 A1
(43) Pub. Date: Jun. 5, 2008

(54) VARIABLE INDUCTOR

(75) Inventor: Javad KHAJEHPOUR, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: SIRIFIC WIRELESS CORPORATION, Waterloo (CA)

(21) Appl. No.: 11/564,980

(22) Filed: Nov. 30, 2006

(51) Int. Cl. H01F 29/06; H01F 5/00

(52) U.S. Cl. 336/139; 336/200

(57) ABSTRACT

The present invention is directed at an inductor which is capable of providing a variable inductance. The variable inductor is typically mounted/stored on an integrated circuit chip to provide continuous or multiple variable inductor values for wireless applications and the like.

### FIELD OF THE INVENTION

The present invention relates generally to integrated circuits. More particularly, the present invention relates to a variable inductor for an integrated circuit.

### BACKGROUND OF THE INVENTION

In the field of integrated circuits, technology is rapidly improving and new methods of implementing analog circuit blocks on integrated circuits are being realized. Furthermore, components of these analog circuit blocks are consistently being upgraded to improve their operational capacity. One such component is a variable inductor. Various examples of variable inductors are currently known and described in US Patent Application No. 2004/0140528 entitled “STACKED VARIABLE INDUCTOR” which was published on Jul. 22, 2004 and US Patent Application No. 2005/0068146 entitled “VARIABLE INDUCTOR FOR INTEGRATED CIRCUIT AND PRINTED CIRCUIT BOARD” which was published on Mar. 31, 2005,

FIG. 1 shows a prior art embodiment of a variable inductor 10. The variable inductor 10 is formed with a primary conductor 12, a secondary conductor 14, and a switch 16. Primary conductor 12 implements a three-port inductor and is formed in a double spiral pattern. The primary conductor 12 is fabricated almost entirely on a low-loss metal layer (e.g. copper) except for one underpass 20 used to interconnect the two sections of the primary conductor 12. Interconnects 22a and 22b of primary conductor 12 form two ports of the inductor and are not routed on an underlayer in order to achieve low-loss. A ‘tap’ pin forms the third port of the inductor and is provided with a power supply voltage, which is used by circuit components coupled to primary conductor 12.

Secondary conductor 14 is formed on the outside of, at a distance away from, the double spiral of primary conductor 12. To attain low resistance, secondary conductor 14 is also fabricated almost entirely on the low-loss metal layer. Secondary conductor 14 is coupled in series with switch 16 and forms a loop 26 that is concentric with the double spiral for primary conductor 12. The switch 16 functions to either open or close the loop and can be placed anywhere on the loop. However, since an underpass is needed to interconnect the two ends of secondary conductor 14, switch 16 is fabricated on an underlayer and between the two interconnects 22a and 22b for primary conductor 12, as shown.

However, many current variable inductors, such as the one shown in FIG. 1, can not be used as a continuous variable inductor since they are not connected to the primary inductor and therefore the range of inductance values provided by the inductor is very narrow.

Furthermore, some current variable inductors operate at a low quality (Q) factor which affects the overall operation of the analog circuit and ultimately the integrated circuit.

It is, therefore, desirable to provide a variable inductor which overcomes some of the disadvantages of the prior art.

### SUMMARY OF THE INVENTION

The present invention is directed at an inductor which is capable of providing a variable inductance. The variable inductor is typically mounted/stored on an integrated circuit chip to provide a continuous multiple-value variable inductor for wireless applications and the like.

In one embodiment, the variable inductor includes a primary conductor which is surrounded by a secondary conductor. The conductors are operatively connected by a set of switches. When the switches are opened, the variable inductor provides a first inductance and when the switches are closed, the variable inductor provides a second inductance. By operatively connecting the primary and secondary conductors via the set of switches, the invention provides a higher inductor quality factor (Q) than other known variable inductors. Furthermore, the variable inductor may be used as a continuous variable inductor by using a transistor in triode for the set of switches.

It is an object of the present invention to obviate or mitigate at least one disadvantage of previous variable inductors.

In a first aspect, the invention provides an apparatus for providing a variable inductance comprising a primary conductor; a secondary conductor; and a set of switches operatively connecting the primary conductor and the secondary conductor; wherein the variable inductance is provided by an opening or closing of the set of switches or by changing the resistance of the switches.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram of a prior art variable inductor;

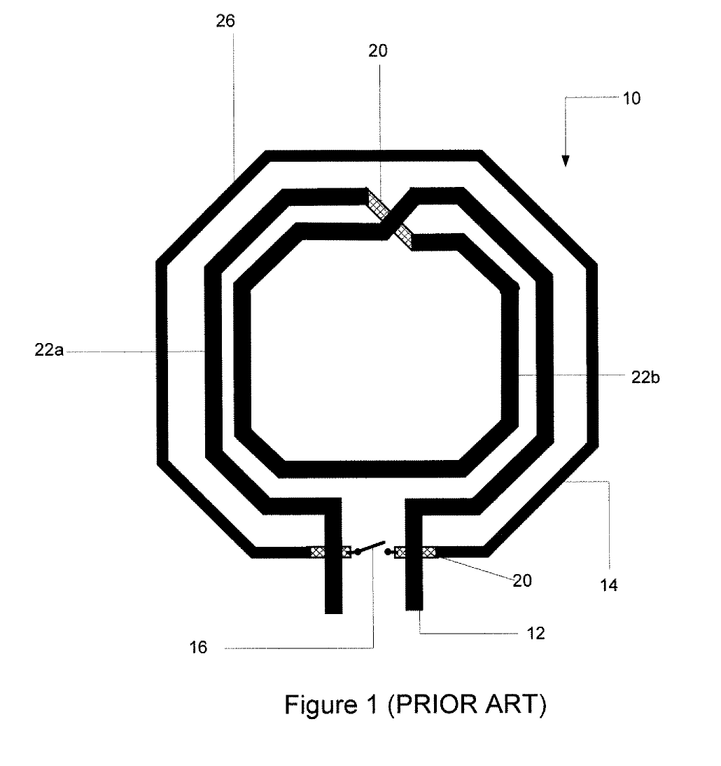

FIG. 2 is a schematic diagram of a variable inductor in accordance with the invention;

FIG. 3a is a schematic diagram of a second embodiment of a variable inductor in accordance with the invention;

FIG. 3b is a schematic diagram of a third embodiment of a variable inductor in accordance with the invention;

FIG. 4 is a schematic diagram of a fourth embodiment of a variable inductor in accordance with the invention;

FIG. 5a is a graph illustrating Q versus switch resistance; and

FIG. 5b is a graph illustrating Inductance versus switch resistance.

### DETAILED DESCRIPTION

Generally, the present invention provides a method and system for implementing a variable inductor for an integrated circuit.

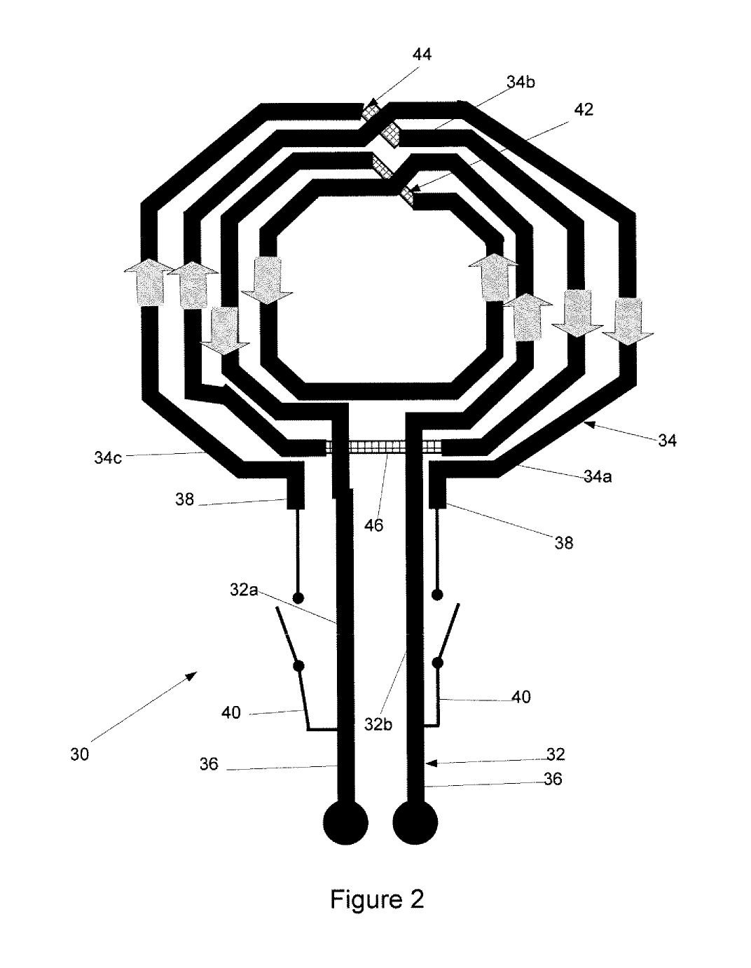

Turning to FIG. 2, a first embodiment of a variable inductor in accordance with the invention is shown. The variable inductor 30 comprises a primary conductor 32 and a secondary conductor 34. The primary conductor 32 and secondary conductor 34 are preferably differential inductors. Ends 36 of the primary conductor 32 are operatively connected to ends 38 of the secondary conductor 34 via a pair of switches 40.

The primary conductor 32 comprises two sections 32a and 32b connected together by an underpass 42 while the secondary connector 34 comprises three sections 34a, 34b and 34c which are connected by a pair of underpasses 44 and 46. In operation, if the pair of switches 40 are open, there is no current flowing through the secondary conductor 34. As there is only current flowing through the primary conductor 32, the variable inductor 30 provides a constant inductance value.

However, when the set of switches 40 are closed, thereby operatively connecting the primary conductor 32 and the secondary conductor 34, current flows through both of the conductors 32 and 34. As will be understood, the direction of current flow in the primary conductor 32 is in the same direction of the current flow in the secondary conductor 34 causing positive mutual coupling on the primary conductor 32. By changing the resistance of the set of switches 16, the inductance may be varied, allowing the inductor to be a variable inductor 30. The resistance levels of the switches 40 may be set at whatever level the implementer desires. In another embodiment, the set of switches 40 may be a transistor in triode.

In this manner, the inductor 30 may be see as a continuous variable inductor 30 since the inductor is continuously operable whether the switches are opened or closed. Furthermore, the inductor is variable since the resistance of the set of switches may be changed while they are open so that when they are closed, the overall inductance value of the inductor is changed. Moreover, the inductance is also varied when the switches are transistors in triode. Variation is due to the switch resistance being able to change from a very low value to a very high value. The overall configuration including the primary and the secondary conductors are considered together to be a variable inductor.

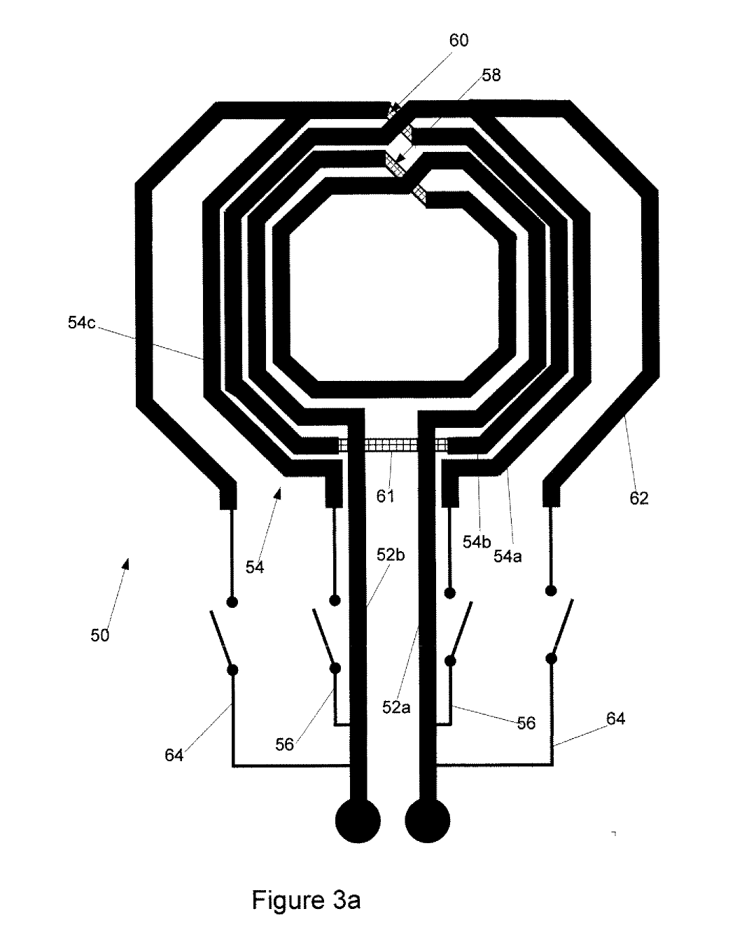

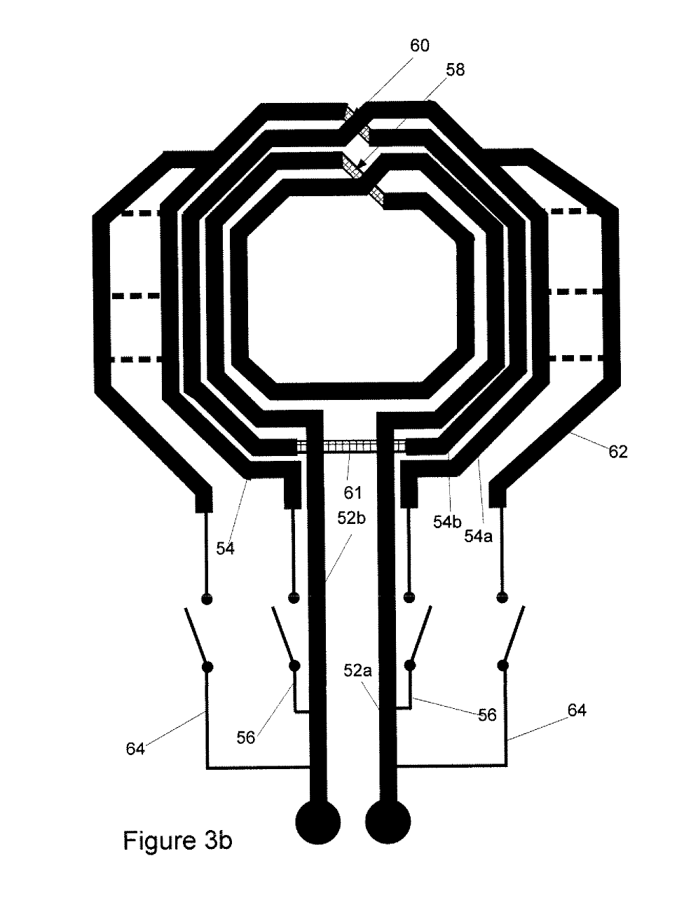

Turning to FIG. 3, another embodiment of a variable inductor in accordance with the invention is shown. The variable inductor 50 comprises a primary conductor 52 and a secondary conductor 54 operatively connected by a set of switches 56. As with the variable inductor of FIG. 2, the primary conductor 52 comprises two sections 52a and 52b which are connected together by an underpass 58 while the secondary conductor 54 comprises three sections 54a, 54b and 54c which are connected together by a set of underpasses 60 and 61.

A tap 62 surrounds the secondary conductor 54 and is operatively connected via a second set of switches 64 to the primary conductor 52. The tap 62 is connected to the secondary conductor 54 at the end away from the sets of switches 56 and 64. The tap 62 allows for the inductance of the inductor 50 to be further varied. Therefore, different values of inductance are achieved when both sets of switches are opened (current flowing through the primary conductor 52), only the set of switches 56 are closed (current flowing through the primary and the secondary conductors 52 and 54), only the set of switches 64 are closed (current flowing through the primary conductor 52 and the tap 62) and both the sets of switches 56 and 64 are closed (current flowing through the primary and secondary conductors 52 and 54 and the tap 62).

Turning to FIG. 3b, as schematically shown, the tap 62 may be connected at any location, as indicated by the dashed lines, to the secondary conductor 54 and does not have to be at an end as shown in FIG. 3a. It will be understood that the location of the contact between the tap 62 and the secondary conductor 54 allows for different inductance values.

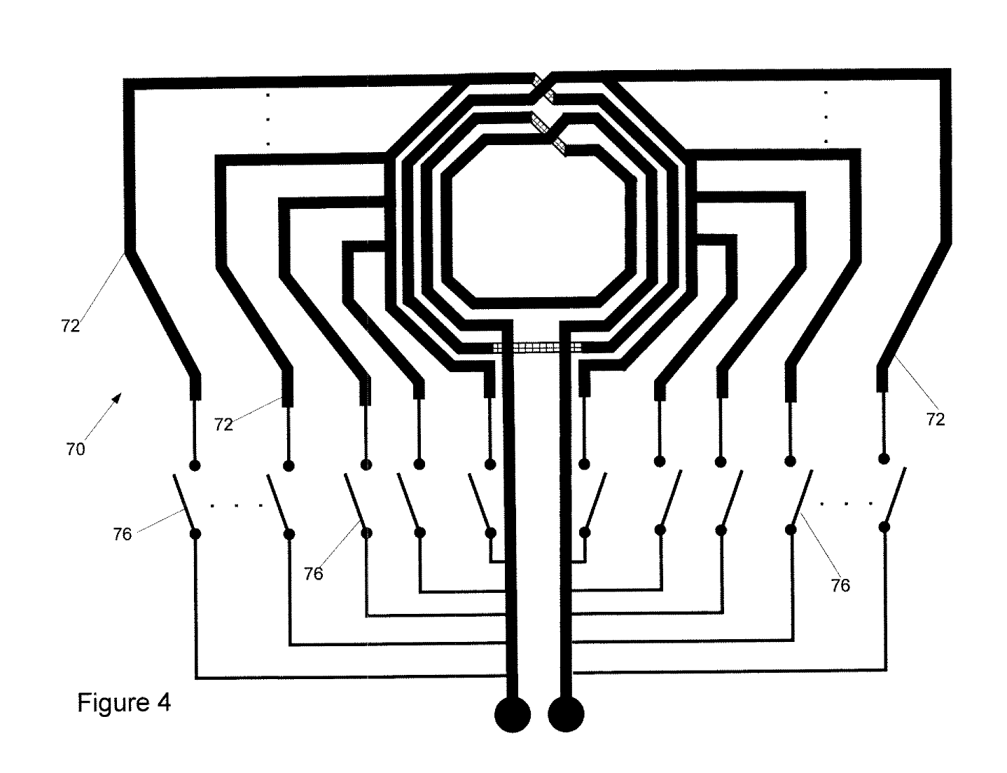

Turning to FIG. 4, yet a further embodiment of a variable inductor is shown. In this embodiment, the variable conductor 70 is similar to the inductor 50 of FIG. 3 with the addition of multiple taps 72. As will be understood, there is no limit to the number of taps 72, however, this number is dependent on the amount of space available within the analog circuit block/integrated circuit. Each of the taps 72 are operatively connected to the primary conductor 52 via individual pairs of switches 76 and provide the functionality of varying the inductance of the variable inductor 70 in a manner similar to the one discussed above. The inductance is varied in accordance with the number of pairs of switches 76 that are opened or closed at a specific moment. The closed switches impart a resistance to the current flowing through the inductor to vary the inductance level in the inductor 70.

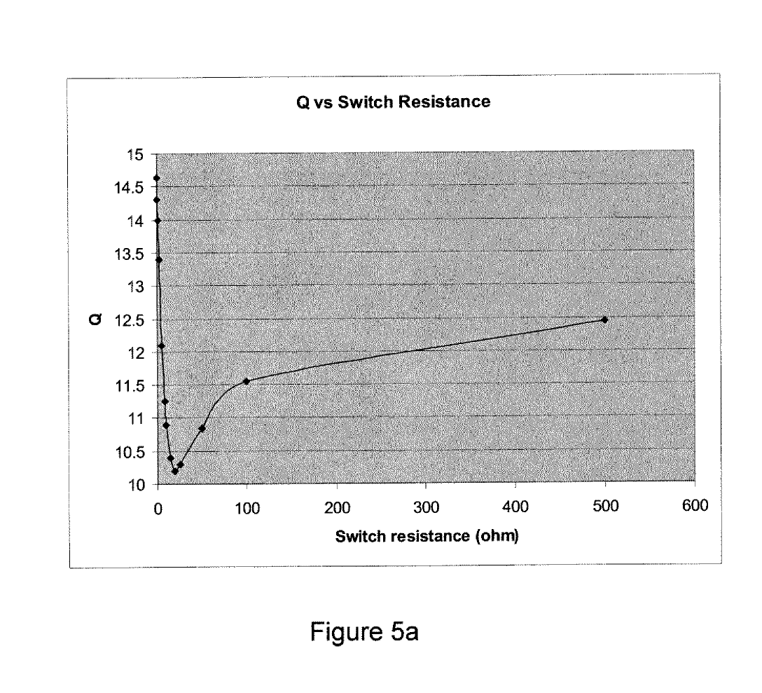

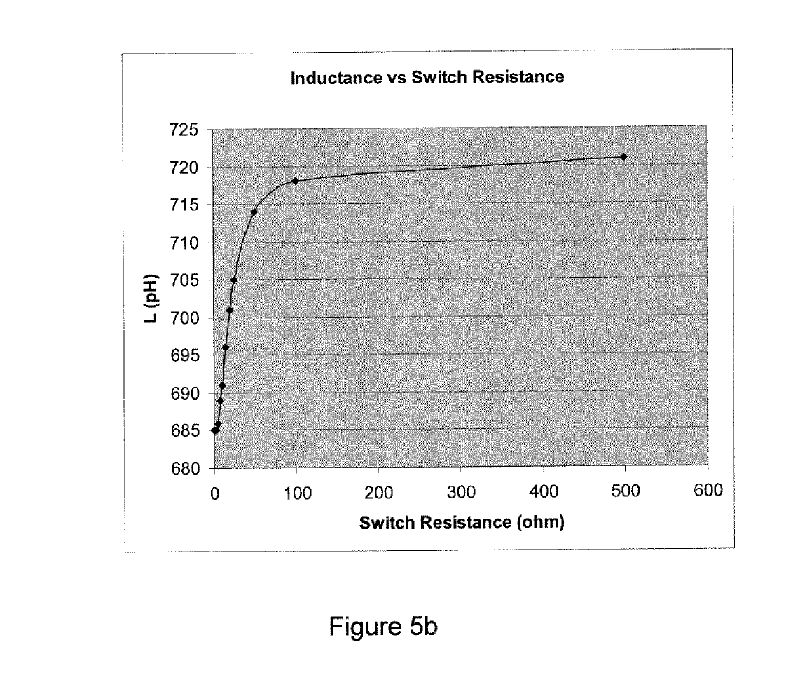

Turning to FIGS. 5a and 5b, graphs showing a variation of the inductance quality factor (Q) and the inductance with respect of the resistance to the set of switches is shown. As described above, the resistance of the set of switches may be varied in order to vary the inductance provided by the inductor. In comparison with one prior art inductor, at an inductance value of 604 pH, the prior art inductor provides a Q value of 9.6 while with the inductor of the invention, at an inductance value of 597 pH, the Q value is 14.2.

A further advantage of the invention is that the quality factor (Q) is increased over other current variable inductors. Yet another advantage is that since the traces are active and connected to the inductor, Q does not drop. Furthermore since the inductors are in parallel, the resistance of the switches is in parallel as well, therefore the switch resistance has less effect on the Q of the inductor. Finally, when a large resistor is placed at the gate of the transistor, the gate floats. In order to decrease the parasitic capacitance of the switch transistors, a large resistor may be connected to the gate of the switch transistors. By using this resistor, the parasitic capacitance of the switch is reduced and therefore the dynamic range of the variable inductor is increased.

In an alternative embodiment, the body of the switches (when they are transistors) may be connected to the source to reduce the body effect or to switch parasitic caps. In another embodiment, a resistor may be placed in series with the gate of a switch to decrease this effect. The resistor at the gate and the connection of the body to the source may be done together to reduce the switch resistance and also reduce the parasitic capacitance.

The above-described embodiments of the present invention are intended to be examples only. Alterations, modifications and variations may be effected to the particular embodiments by those of skill in the art without departing from the scope of the invention, which is defined solely by the claims appended hereto

What is claimed is:

1. Apparatus for providing a variable inductance comprising:
a primary conductor;
a secondary conductor; and
a set of switches operatively connecting said primary conductor and said secondary conductor;
wherein said variable inductance is provided by an opening or closing of said set of switches.

2. The apparatus of claim 1 further comprising a set of taps surrounding said primary and secondary conductors.

3. The apparatus of claim 2 wherein said taps are connected by switches to the secondary conductor.

4. The apparatus of claim 1 further comprising a set of taps located at any position outside said secondary conductor.

5. The apparatus of claim 4 wherein said taps are connected by switches to the secondary conductor.

6. The apparatus of claim 1 wherein said primary conductor is spiral in shape.

7. The apparatus of claim 1 wherein said secondary conductor is spiral in shape.

8. The apparatus of claim 7 wherein said secondary conductor is in close proximity to said primary conductor.

9. The apparatus of claim 8 wherein said secondary conductor is surrounding said primary conductor.
